(19) United States
(12) Patent Application Publication
(10) Pub. No.: US 2008/0316976 A1
(43) Pub. Date: Dec. 25, 2008

(54) METHOD AND APPARATUS FOR SIGNALING INTERWORKING CDMA 3G1x MOBILES AND EVDO MOBILES WITH AN IMS CORE NETWORK

(75) Inventors: Robin Jeffrey Thompson, Batavia, IL (US); Alex Lawrence Wierzbicki, Bolingbrook, IL (US)

Correspondence Address: FAY SHARPE/LUCENT, 1100 SUPERIOR AVE, SEVENTH FLOOR, CLEVELAND, OH, 44114, US

(73) Assignee: LUCENT TECHNOLOGIES, INC., Murray Hill, NJ (US)

(21) Appl. No.: 11/767,828

(22) Filed: Jun. 25, 2007

(51) Int. Cl. H04B 7/216

(52) U.S. Cl. 370/335

(57) ABSTRACT

A basestation 3G1x network architecture which is used to convert 3G1x control and signaling to IMS/SIP in basestation is disclosed. The system includes a user agent that bi-directionally translates between SIP messaging and CDMA messaging. The system also includes a 1x basestation emulator which may act as an interface for the 3G1x handset. The basestation emulator is also configured to terminate CDMA mobile protocol and interconnect messages and operations with the user agent. The methods include mapping between the CDMA mobile message and the SIP message through the basestation emulator and the SIP user agent. The method may facilitate basestation origination and termination as well as feature services. These feature services may include three way calling, call waiting and call waiting with caller identification.

### BACKGROUND OF THE DISCLOSURE

This disclosure relates to a method and apparatus for interworking 3G1x call control and signaling with signaling used by an Internet Multimedia Subsystems (IMS) network. More particularly, this disclosure relates to a method and apparatus for interworking of 3G1x call control and signaling used by Code Division Multiple Access (CDMA) mobiles with the Session Initiation Protocol (SIP) signaling used by IMS core network.

While this disclosure is particularly directed towards the signaling and the control interface used by CDMA mobiles that utilize the IMS network, and thus will be described with specific reference thereto, it will be appreciated that the disclosure may have usefulness in other fields and applications. For example, this disclosure may be used in a variety of data transfer systems and methods including supporting gradual migration from one network to another, thereby allowing service providers to invest their time and energy in future IMS technology.

By way of background, CDMA mobiles are used all over the world. Many people use these mobile stations in order to transfer voice and data through a well established radio network. Currently, there are many known methods for configuring voice path transfers through the CDMA ratio network.

The IMS/SIP based network is an internet protocol based network that supports many other types of handsets. These handsets use Voice over Internet Protocol (VoIP) and other methods to transfer data and voice in real time applications across the Internet Protocol (IP) network.

Currently, the IMS network is less commonly used in order to transfer voice and data. However, the IMS network is quickly gaining popularity over other networks. Currently in the industry there is no effective way to convert a signal from the CDMA network to an IMS network. The current systems in place only allow IP signals to be covered on the IP network and CDMA signals to be covered on the CDMA network. There is a need in the industry to allow IMS network coverage and capacity to be extended to signals originally made to be transferred over other networks. There is further a need for these signals to be converted and received on an IMS network and managed through a seamless means. There is also a need for a basestation which will allow hand offs to and from the IMS network to the CDMA network. There is also a need in the industry to supply a data network and allow for IP awareness to take place on the CDMA network.

The present invention contemplates a new and improved system that resolves the above-referenced difficulties and others.

### CROSS REFERENCE TO RELATED PATENTS AND APPLICATIONS

This application is related to U.S. application Ser. No. 11/758,477, filed Jun. 5, 2007, entitled METHOD AND APPARATUS TO ALLOW HAND-OFF FROM A MACROCELL TO A FEMTOCELL, Inventors John Kenney Burgess and Robin Jeffrey Thompson, Attorney Docket No. Burgess 14-25/LUTZ 2 00526; U.S. application Ser. No. 11/758,555, filed Jun. 5, 2007, entitled SESSION INITIATION PROTOCOUINTERNET PROTOCOL MULTIMEDIA SUBSYSTEM BASED ARCHITECTURE FOR SUPPORTING 3G1x VOICE/DATA, Inventors John Kenney Burgess, Andrew C. Clark, James Ray Freeburg, Hoo Dennis Ong, Maria E. Palamara, K. Jeffrey Rabourn, Robin Jeffrey Thompson and Alex Lawrence Wierzbicki, Attorney Docket No. Burgess 15-4-3-1-8-2-26-19/LUTZ 2 00527; U.S. Ser. No. 11/758,557, filed Jun. 5, 2007, entitled METHOD TO ALLOW HAND-OFF OF A CDMA MOBILE FROM IMS FEMTOCELL TO CIRCUIT MSC, Inventor Robin Jeffrey Thompson, Attorney Docket No. Thompson 27/LUTZ 2 00528; U.S. application Ser. No. ______, filed ______, entitled METHOD AND APPARATUS FOR PROVISIONING AND AUTHENTICATION/REGISTRATION FOR FEMTOBSR USERS ON IMS CORE NETWORK, Inventors Maria E. Palamara and Robin Jeffrey Thompson, Attorney Docket No. Palamara 9-29/LUTZ 2 00540. These applications are hereby incorporated by reference.

### SUMMARY OF THE INVENTION

A system and method for signal interworking of CDMA 3G1x mobiles and EVolution Data Optimized (EV-DO) mobiles with an IMS core network is provided. This disclosure will allow for its conversion of a call that originated over a CDMA network to be carried and processed to an IP based network without changing or manipulating the mobile unit or current network architecture in place.

In one aspect of the disclosure, the method includes receiving an incoming CDMA message from an associated mobile station, mapping between the CDMA mobile message and a SIP message through a basestation emulator and SIP user agent and sending the resultant SIP message to an associated IMS.

In another aspect of the present disclosure, the method includes acknowledging messages between the CDMA network and the associated IMS where mapping is not required and still satisfying signal protocol requirements.

In accordance with another aspect of the present disclosure, the method includes parsing the incoming CDMA message into multiple classes for transmission to the SIP user agent.

In yet another aspect of the present disclosure, the method includes that the multiple classes are divided into either operations or messages.

In accordance with yet another aspect of the present disclosure, the method includes facilitating subscriber features, such as, call waiting, call waiting with caller identification and three-way calling.

In accordance with yet another aspect of the present disclosure, the method includes assigning a traffic channel via the basestation emulator for voice and data communications.

In accordance with another aspect of the present disclosure, a system for facilitating communication between CDMA mobile units and the IMS network includes a user agent that bi-directionally translates between SIP messages and parsed CDMA mobile messages and a basestation emulation configured to act as an interface for a 3G1x handset terminating CDMA mobile protocol and interconnect messages and operations with the user agent.

In accordance with another aspect of the present disclosure, the system includes being housed within a basestation.

In accordance with another aspect of the present disclosure, the system is housed within a femto basestation.

In accordance with another aspect of the present disclosure, the system includes that the basestation is configured to assign traffic channels during a call origination sequence.

In accordance with another aspect of the present disclosure, the system includes that the basestation is configured to assign traffic channels during a call termination sequence.

In accordance with another aspect of the present disclosure, the system includes a billing database that tracks billing information for calls being processed through the basestation.

In accordance with another aspect of the present disclosure, the system includes a media resource function that processes requests for media services.

In accordance with yet another aspect of the present disclosure, a method for interworking a 3G1x call control and signaling with SIP signaling includes receiving an incoming SIP message at a user agent, translating the SIP message to CDMA between the user agent and a basestation emulator, sending the message via CDMA to the associated mobile unit, which is configured to communicate through CDMA messaging.

In accordance with another aspect of the present disclosure, the method includes recognizing communicated messages that do not require translation for processing and transmitting the communication message through signal protocol.

In accordance with another aspect of the present disclosure, the method includes that incoming SIP messages are received from an associated IMS core.

In accordance with another aspect of the present disclosure, the method includes assigning a traffic channel via the basestation emulator for call origination and/or termination.

### DESCRIPTION OF THE DRAWINGS

The presently described embodiments exist in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates a portion of the overall communication system, including a basestation emulator, a SIP user agent, an IMS core, a billing database and a CDMA mobile station.

FIG. 2a is a flow diagram illustrating one embodiment of call origination of the method according to the present disclosure.

FIG. 2b is a continuation of FIG. 2a.

FIG. 3a is a flow chart diagram illustrating another embodiment call termination of the method according to the present disclosure.

FIG. 3b is a continuation of FIG. 3a.

FIG. 4a is a flow chart diagram illustrating another embodiment call waiting of the method according to the present disclosure.

FIG. 4b is a continuation of FIG. 4a.

FIG. 5a is a flow chart diagram illustrating another embodiment three-way calling of the method according to the present disclosure.

FIG. 5b is a continuation of FIG. 5a.

### DETAILED DESCRIPTION

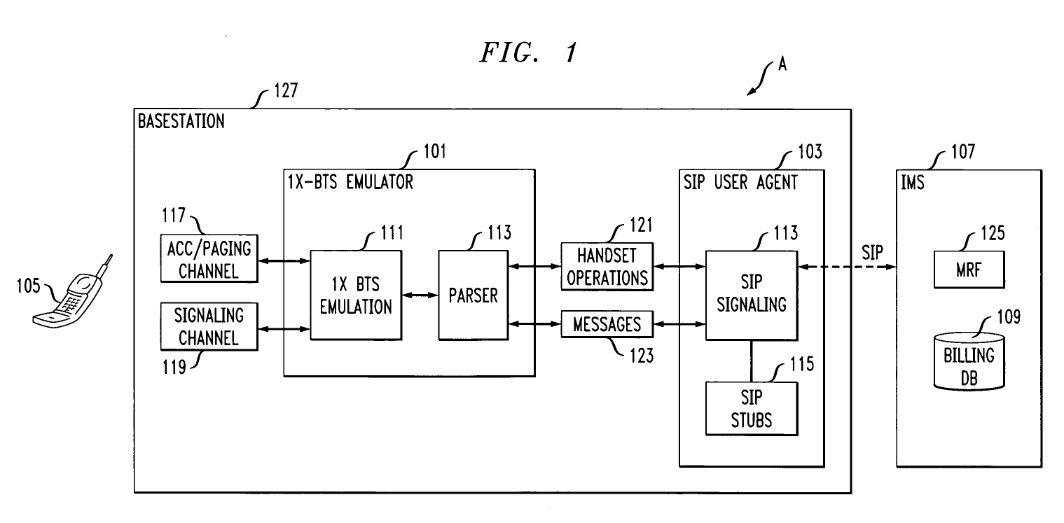

Referring now to the drawings wherein the showings are for purposes of illustrating the disclosed embodiments only and not for purposes of limiting the same, FIG. 1 provides an overall view of a system into which the present disclosure may be incorporated. A communications infrastructure A is shown. The communications infrastructure A includes a basestation 127, an Analog control channel (Acc)/paging channel 117, a signaling channel 119, basestation emulator, a parser 113, handset operations 121, messages 123, SIP signaling 113, SIP stubs 115, a SIP user agent 103, an IMS 107, a billing database 109, and a Media Resource Function (MRF) server 125. It should be understood that this represents but one embodiment of the communications network infrastructure A. The present disclosure could be incorporated in a variety of communication network configurations.

In operation, as discussed in greater detail below, the presently described embodiments are directed network architecture towards converting 3G1x control and signaling to IMS/SIP in a basestation. In this sense, this disclosure describes a solution to the current problem which involves transferring CDMA 3G1x voice to an MSC core network which uses a legacy circuit base solution. Because wireless service providers' further plans are to evolve their core network to IMS in order to support VoIP and other multimedia services over EV DO Rev A, this system is useful and convenient. Because it is important to have one core network which supports both 3G1x voice and EV DO Rev A, there is a need for interworking of 3G1x call control and signaling with SIP signaling. Without this interworking relationship, the system would lack user control for basic call set up as well as advanced services.

Still referring to FIG. 1, the system includes an associated mobile station 105. The mobile station 105 is configured to communicate to basestation through CDMA signaling. This communication may take place over the Access paging channel (Acc) 117 and/or signaling channel 119. These channels are in communication with a basestation emulator 101. The basestation emulator 101 contains within it a basestation emulation server 111 and a parser 113. The parser 113 may communicate signals in the form of handset operations 121 and messages 123. The signals are received by a signaling server 113 and SIP stubs server 115. These two servers are contained within a SIP User Agent (UA) 103. The SIP user agent 103 is in communication with the IMS 107 which is also in communication with a billing database 109 and an MRF server 125. The basestation emulator 101 and SIP user agent 103 may be housed inside of a basestation 127.

As described in further detail below, this communication network may include other network elements, for example, switches, gateways, etc. These communication networks may also include other networks such as cellular networks, VoIP networks, the internet, etc.

Continuing on with FIG. 1, this embodiment includes a mobile station 105. However, other user equipment besides a mobile station may be substituted. Other examples of user equipment include, but are not limited to, wireless telephones, VoIP telephones, laptop computers, etc. These devices are typical user equipment used to communicate through compatible lines. In this embodiment, the mobile station 105 is a CDMA 3G1x handset.

Through this disclosure, a call may be processed through an Acc/paging channel 117, and/or a signaling channel 119. Typically, the mobile station 105 is configured to send these signals to be received by a 1x basestation. However in this embodiment, the basestation includes a basestation emulator which may receive these signals without manipulating the infrastructure of the CDMA mobile 105.

The basestation emulator 101 includes a basestation emulation server 111 and a parser 113. The basestation emulation server 111 is configured to receive these signals and send them to the parser 113. The parser 113 in turn may divide the signal into different classes. These classes include handset operations 121 and messages 123.

At this point, the system converts the CDMA messages into SIP messaging. However, it should be noted that not all CDMA messages have a need to be converted. Some of these messages may not have a one to one translation to or from SIP. Some of these are SIP messages that can get handled solely by the SIP UA 103 and are not interworked to 3G-1X i.e. SIP OPTIONS. These may be handled by the SIP stubs server 115. As disclosed in further detail below, the message conversion will depend on which messages are being received through the basestation emulation server 111.

The signal is divided into two portions, the bearer portion and the signaling portion. The basestation emulator 101 is used in order to convert both parts of the signal. The signal is converted in order to be processed by a SIP base system. In this embodiment, the IMS 107 on the bearer path Enhance Variable Rate Codec/Radio Link Protocol (EVRC/RLP) is converted into EVRC/Reliable Transport Protocol (RTP) in the basestation 127. RLP is generally used for communication between a mobile station and a basestation. RTP is used in multimedia real time traffic transportation across IP networks. For the signaling portion 119 of the basestation 127, the signal is converted to SIP protocol.

These messages are now received by a SIP user agent 103. SIP user agent 103 contains a SIP signaling server 113 and SIP stubs 115. The SIP stubs does not map to Radio Network Controller (RNC) operations. As stated in the previous paragraph, some of these operations do not need to be translated to SIP messaging.

The SIP user agent 103 transfers the signal to the IMS 107 in order to be processed. These messages are transferred in SIP because the IMS 107 does not utilize CDMA protocol.

The IMS network 107 may include a variety of network elements. These elements may include a feature server, a call session control function, a home subscriber server, a mobility management application server, a visitor location register and a handoff application server. It should be noted that these elements in the IMS network are but one embodiment of the disclosure. These elements may also be configured in a number of ways and still fall within the spirit and scope of the claims. The IMS network 107 takes the signal and processes the call using a variety of network elements. The IMS 107 may also facilitate handoffs to and from this network and other networks.

The MRF server 125 is also in communication with the IMS network 107. The MRF 125 provides a foundation for many advanced multimedia services. These services include interactive services as well as feature services, such as call waiting, caller id and three way calling. The MRF server 125 may also be used in video response, voice mail, conferencing, music sharing, etc.

A billing database 109 may be used in order to keep billing information. In one embodiment a call being processed through the network will have a special charge. In other embodiments it will be billed as any other mobile call. The billing database 109 is used to process and track billing data associated with a call processed through this method.

In this embodiment, the CDMA call is being processed through a basestation 127. This basestation may be a femto basestation, a macro basestation or any other basestation or similar network element known in the art. Furthermore, this basestation may be configured in a number of ways and the processes of the basestation may be implemented through a variety of matters.

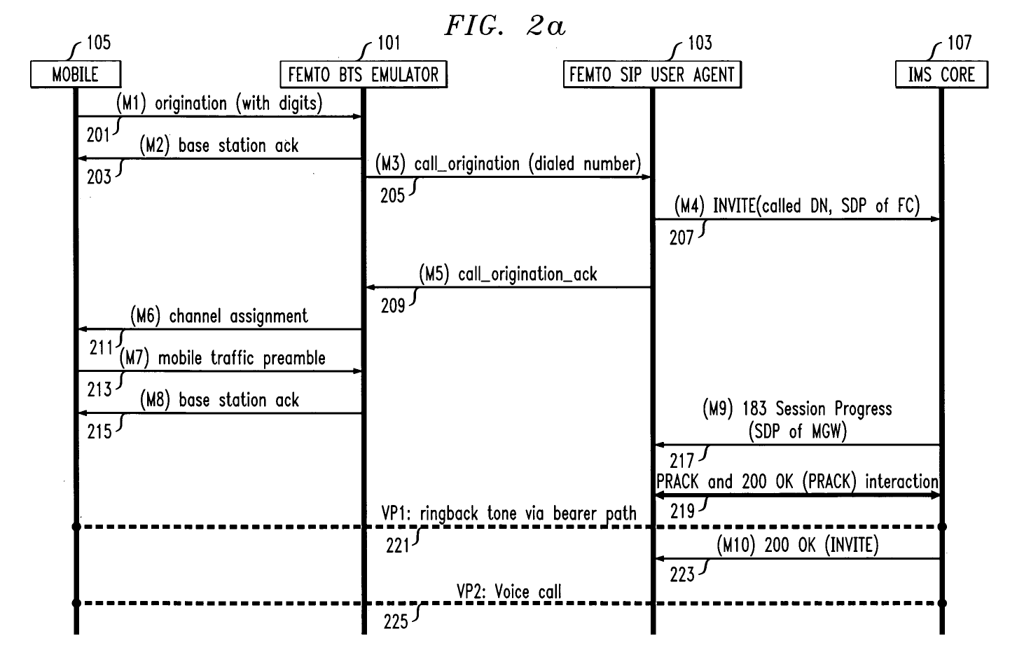

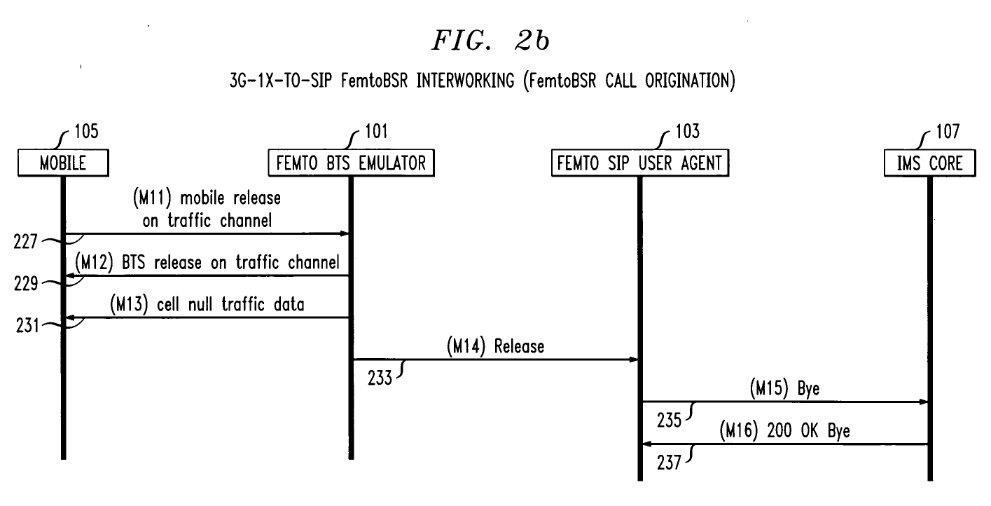

Now referring to FIG. 2a, which is a flow chart illustrating one embodiment of the method according to the present disclosure. This disclosed embodiment is basestation call orientation. In this embodiment the mobile 105 originates the call through a basestation to an IMS core 107 which processes the call. The method begins with the assumption that the mobile has powered up and completed registration with the IMS core 107.

The method continues with message 1, origination with digits at step 201. The mobile sends message 1 to the basestation emulator 101. The mobile dials the called party's telephone number and presses “SEND”.

Message 2 is an acknowledgement by the basestation 101 at step 203 which is followed by a call origination which includes the dialed number at message 3 at step 205. With this message, the basestation emulator 101 passes the origination information to the basestation's 127, SIP user agent 103.

This call is then sent in SIP from the SIP user agent 103 to the IMS core at step 207. This message 4 is sent in standard SIP messaging as an invite message. The invite message includes the dialed number and the service delivery point of the basestation. This call may be marked at this point as a basestation origination call for billing purposes. The invite may also include a P-ACCESS NETWORK INFO header, along with the invite message which will signify through the billing database, the nature of this call.

The method continues with the SIP user agent 103 sending a call origination acknowledgment message to the basestation emulator 101. The basestation emulator will then assign a traffic channel for the call to take place. A channel assignment message, message 6 is then sent to the mobile 105 at step 211.

Message 7 includes a mobile traffic preamble at step 213 followed by a basestation acknowledgment of the message at message 8 at 215. Meanwhile, the IMS core 107 will send a session progress message in standard SIP which would be message 9 at step 217.

A Provisional Response ACKnowledgment (PRACK) and 200OK PRACK interaction at step 219 between the IMS core 107 and the SIP user agent 103. Inherently, a PRACK request plays the same role as an acknowledgment request, but for provisional responses. The 200OK PRACK message is the response to PRACK message in normal SIP messaging.

The bearer path will then carry a ring back tone at step 221 between the IMS core 107 and the mobile 105. The IMS core will then send a 200OK invite message at message 10 at step 223. At this point the called party would answer the call and voice path would be established at step 225.

Now referring to FIG. 2b, which is a continuation of FIG. 2a, once the mobile call disconnects, the mobile would send message 11, a mobile release on traffic channel at step 227 to the basestation emulator 101. At that point the basestation would release the traffic channel at step 229 through message 12. At message 13 a cell null traffic data message as standard in the CDMA radio interface would be sent at step 231. The resources would then be cleaned up and released at message 14, at step 233. The SIP user agent 103 would send a bye message at step 235 to the IMS core 107. A 200OK response to the bye message would be sent to message 16 from the IMS core 107 to the SIP user agent 103.

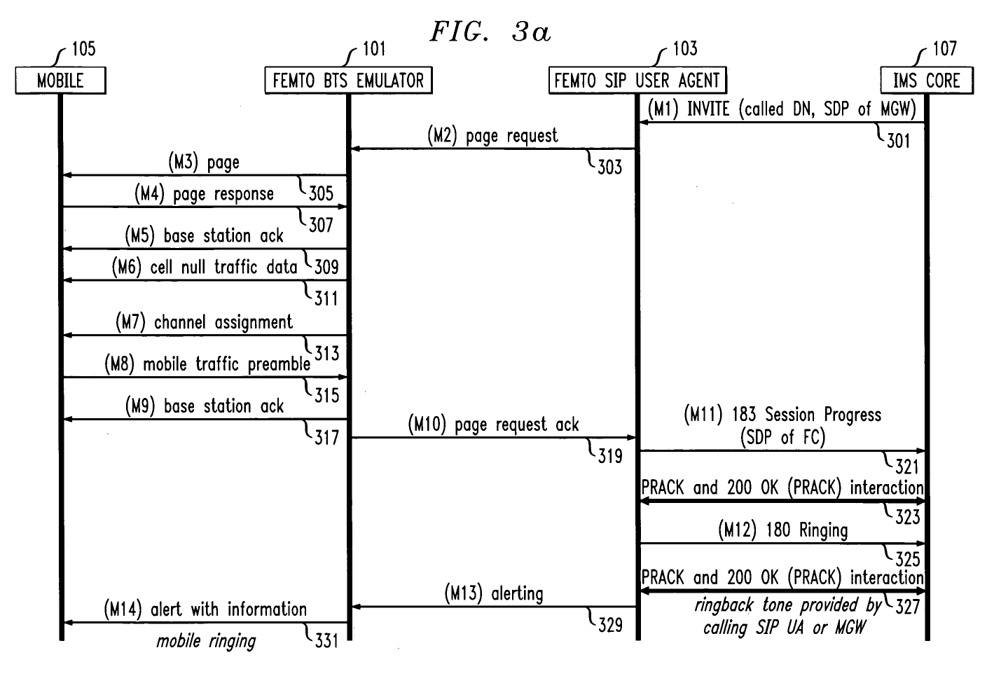

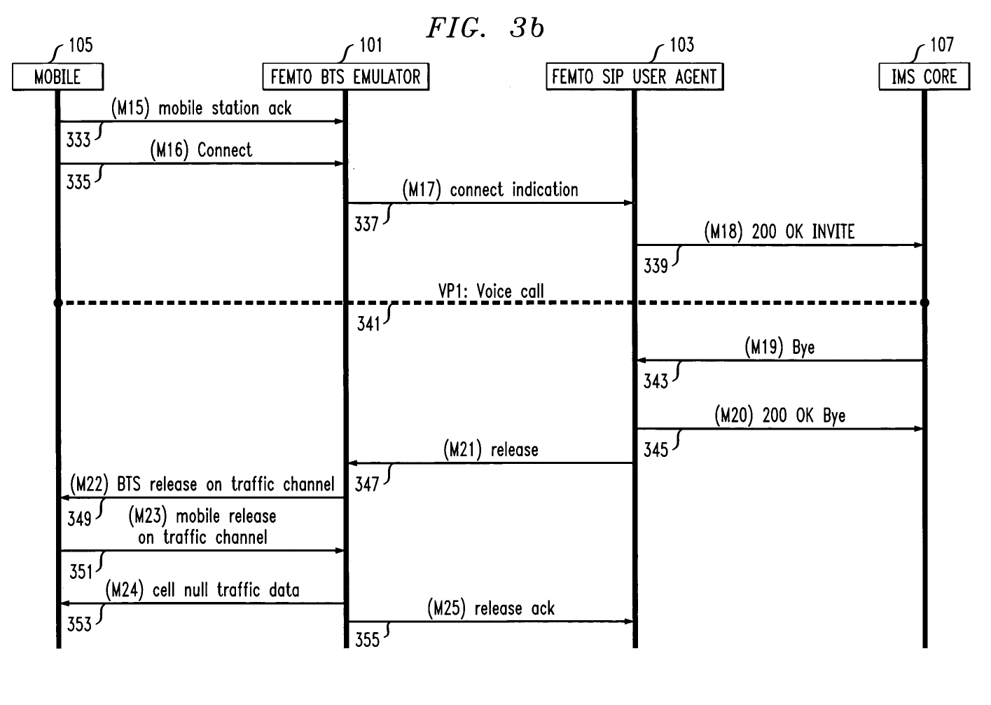

Now referring to FIG. 3 which is an illustration of one embodiment of the disclosed method. This embodiment is basestation call termination. The method begins with an invite message in SIP being sent from the IMS core 107 to the SIP user agent 103 which would receive this message at step 301.

A page request would be sent as message 2 at step 303 from the SIP user agent 103 to the basestation emulator 101. Logically, a page message would be sent from the basestation emulator 101 to the mobile which has previously registered with the IMS core 107. In this sense, the IMS core 107 knows how to locate the mobile 105 and this method assumes that the mobile 105 was powered up and the registration with the IMS 107 was previously successful.

The mobile at step 307 would send a page response as message 4, acknowledging the page that was sent in message 3 from the basestation emulator 101. Once the mobile answer the page, message 5 would include a basestation acknowledgment from the basestation emulator 101 to the mobile 105 at step 309. Thereafter, a cell null traffic data message is sent at message 6 at step 311.

The basestation emulator 101 would then assign a traffic channel for the call to take place. Message 7 would include the traffic channel assignment at step 313. This message would inform the mobile 105 at what channel the call is to take place. The mobile 105 would then respond at step 315 with message 8, a mobile traffic preamble. Message 9 would include a basestation acknowledgment message to the mobile 105 at step 317.

At step 319, message 10 is a page request acknowledgement between the basestation emulator 101 and the SIP user agent 103. This would trigger a series of steps in SIP between the SIP user agent 103 and the IMS core 107. The first of these steps is message 11 at step 321. This is a session progress message which includes the session description protocol of the basestation. At step 323 is the PRACK and 200OK PRACK interaction between the SIP user agent 103 and the IMS core 107. Message 12 is a standard ringing indication message sent in SIP from the SIP user agent 103 to the IMS core 107 and again there would be a PRACK and 200OK PRACK interaction between the two elements at step 327 initiating a ring back tone which may be provided by the calling SIP user agent 103 or the mobile gateway (not shown).

The method continues with the SIP user agent 103 sending message 13 an alerting directive at step 329. This message is sent to the basestation emulator 101. This message is translated into CDMA and sent as message 14 at step 331 to the called mobile 105. This message signals the mobile 105 to begin ringing.

Now referring to FIG. 3b which is a continuation of the basestation call termination embodiment of FIG. 3a. The method continues with a mobile station acknowledgement message through message 15 at step 333. Once the mobile call is answered, message 16, a connect message is sent from the mobile 105 to the basestation emulator 101. The basestation emulator 101 would then send message 17 a connect indication to the SIP user agent 103 at step 337. This would trigger the SIP user agent 103 to send a 200OK invite message, message 18, in SIP to the IMS core 107 at step 339. This establishes a voice call at step 341 between the mobile and the calling party through the IMS core 107.

Message 19 is a bye message at step 343. This message is sent from the IMS core 107 to the SIP user agent 103. Through this message the network would disconnect the call the SIP user agent 103 would send a 200OK bye acknowledgement message to the IMS core 107 at step 345.

The SIP user agent 103 would then send a release message to the basestation emulator 101 at step 347. This will trigger the basestation emulator 101 to release the resources for the call. Through this process at step 349, message 22, the basestation would release the traffic channel. In turn, at message 23, at step 351, the mobile would release the traffic channel. The basestation emulator 101 at step 353 would send message 24 a cell null traffic data message to the mobile at 105. Once the call is released that the resource is cleared, the basestation emulator 101 would send a release acknowledgement message, message 25 at step 355 to the SIP user agent 103.

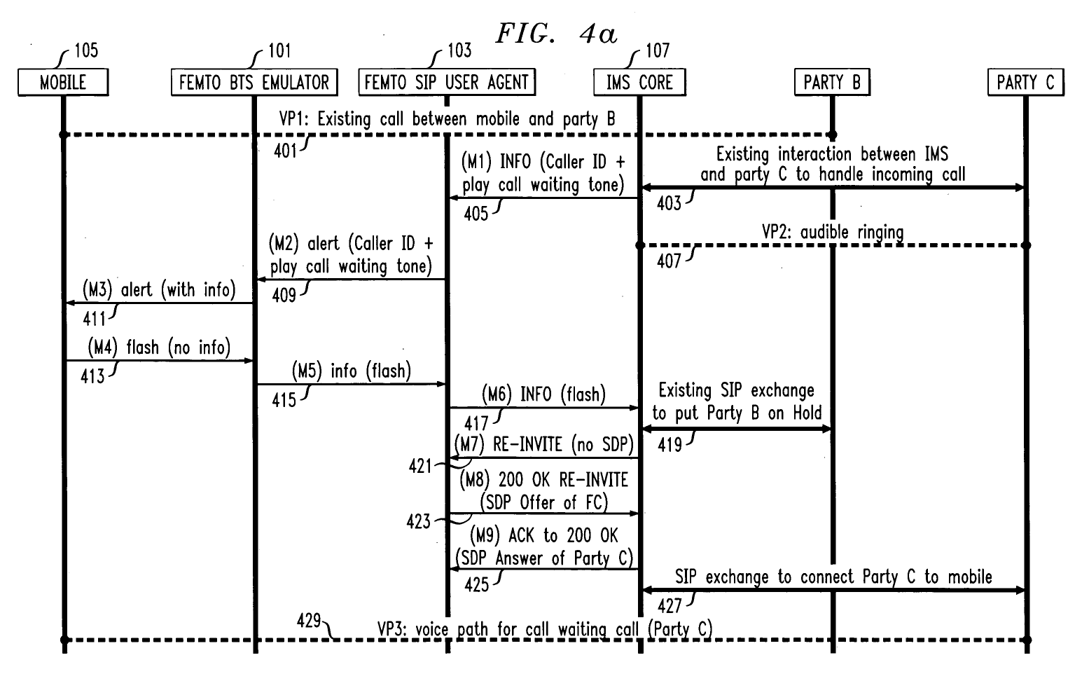

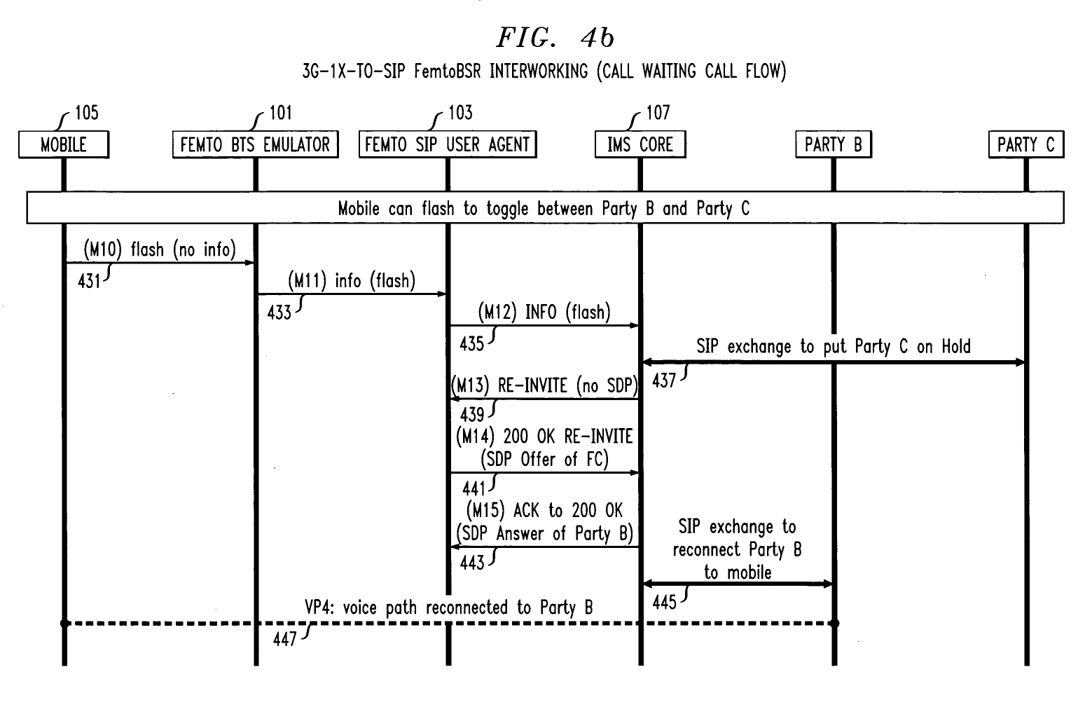

Now referring to FIG. 4 which is another embodiment in this disclosure. This embodiment is a method for call waiting. The method begins with the assumption that the mobile 105 is active on a call with party B and is receiving an incoming call from party C. Step 401 shows the existing call path between the mobile 105 and party B.

Step 403 shows an interaction between the IMS 107 and party C. The IMS 107 is to handle the incoming call from party C at step 403. Message 1 at step 405 is an info message in SIP sent from the IMS 107 to the SIP user agent 103, this message is an info message including the caller identification of party C and the call waiting tone. Step 407 shows the audible ringing established by the IMS core to party C.

Message 2 is an alert message carrying the same message as the info message from step 405. The alert message is shown at step 409. The next message, message 3 is an alert message sent in CDMA from the basestation emulator 101 to mobile 105. The mobile 105 is instructed to alert the user through a call waiting tone and display the calling number of party C. At message 4, at step 413, the mobile 105 answers the ringing call waiting tone and a flash message is sent to the basestation emulator 101. Message 5 includes an info message with the flash information at step 415 from the basestation emulator 101 to the SIP user agent 103. At step 417, message 6, an info message in SIP containing the flash information is sent from the SIP user agent 103 to the IMS core 107. Once the flash message is received from the ISM core 107, party B is placed on hold at step 419.

The IMS core 107 then sends a re-invite message at step 421 to the SIP user agent 103. A 200OK re-invite message is sent back to the IMS core 107 at step 423. Message 9 is an acknowledgement at step 425 from the IMS core 107 to the SIP user agent 103. A SIP exchange is then used at step 427 to connect party C to the mobile 105 through the IMS core 107. This creates a voice path for the call waiting between party C and the mobile 105 at step 429.

The method continues on FIG. 4b, which is a continuation of the call waiting embodiment of FIG. 4. This section of the method begins with the mobile 105 user pressing the flash or send button to reconnect to party B after the initial conversation with party C. Message 10 shows this flash message being sent from the mobile 105 to the basestation emulator 101 at step 431. This flash message is sent as message 11 from the basestation emulator 101 to the SIP user agent 103 at step 433. The flash is relayed as an info (flash) as message 12 at step 435 from the SIP user agent 103 to the IMS core 107. This establishes a SIP exchange to place party C back on hold at step 437.

A re-invite message to reactivate the held call between party B and the mobile station 105 is then sent as message 13 at step 439 from the IMS core 107 to the SIP user agent 103. This message is acknowledged in the form of a 200OK re-invite message shown here at step 441 as message 14. This message is sent from the SIP user agent 103 back to the IMS core 107. Message 15 is an acknowledgement to the 200OK message which is sent from the IMS core 107 to the SIP user agent 103 at step 443. A SIP exchange is then established to reconnect party B back to the mobile at step 445 which creates a voice path reconnecting the two parties shown at step 447. This method could continue on with the mobile user resending the flash message and establishing a connection back with party C as shown earlier, FIG. 4a at step 429.

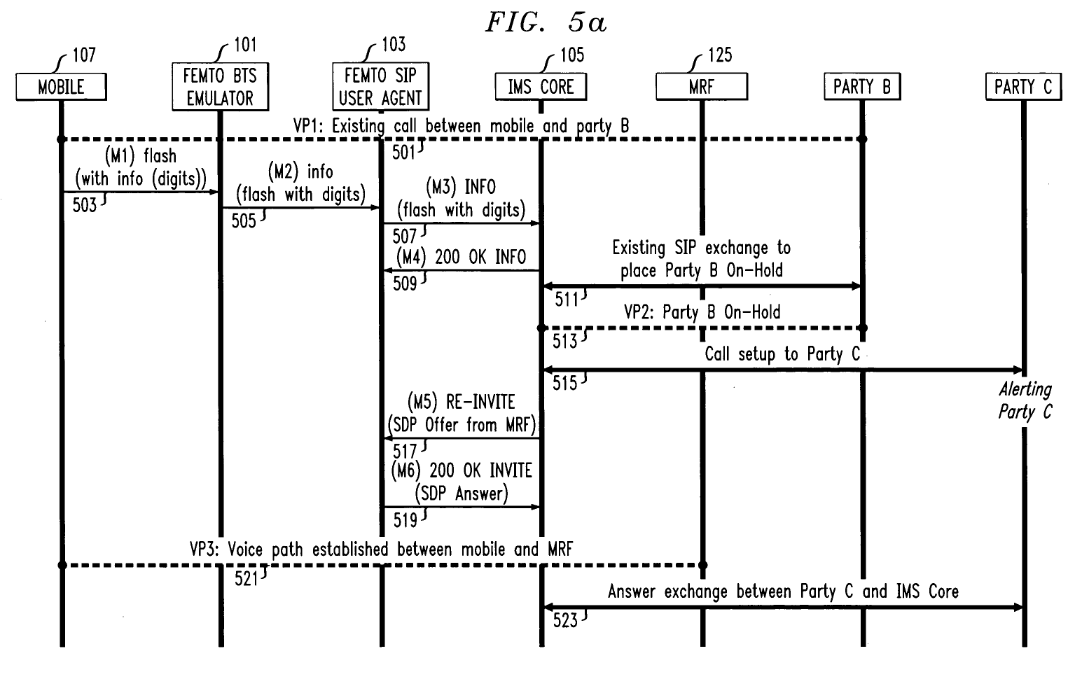

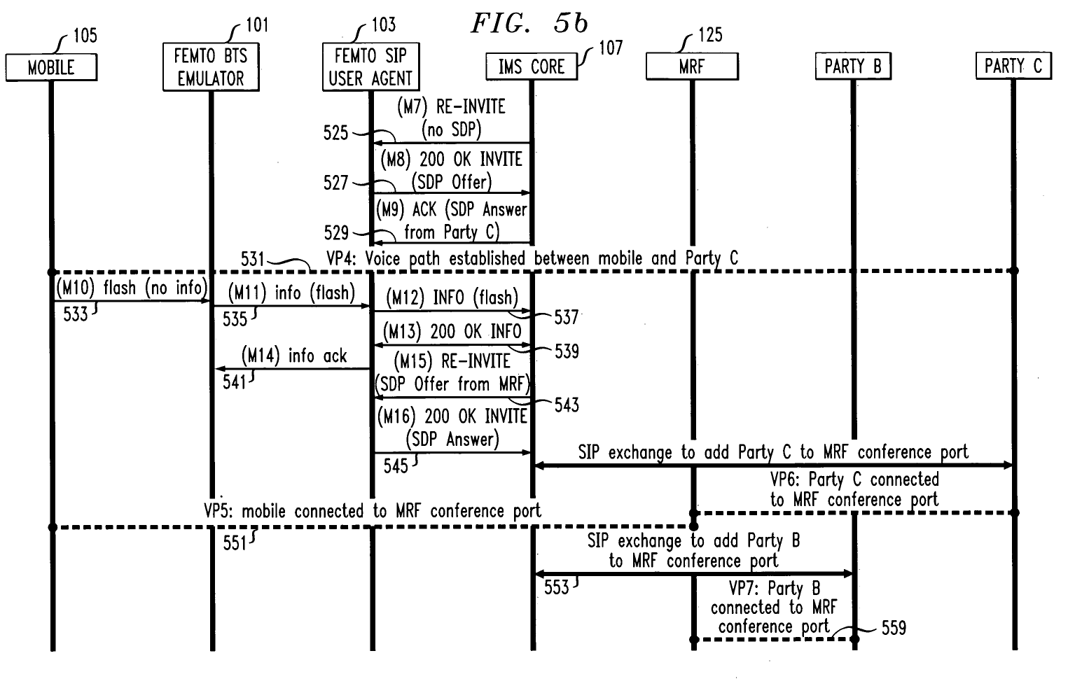

Now referring to FIG. 5a which is a three-way call embodiment of the present disclosure. This three-way call includes two parties connected to a third party using a mobile phone 107. This also includes the basestation emulator 101 and SIP user agent 103 along with the IMS core 107 and a MRF server 125. The method begins with the assumption that the mobile is active and on a call with party B and wishes to invoke three way conferencing with party C. The mobile user enters in party C's phone number and presses the “SEND” button.

The method begins with an existing call between the mobile 105 and party B at step 105. Once the mobile user presses the “SEND” key after entering party C's phone number message 1 is sent from the mobile 105 to the basestation emulator 101 at step 503. This message is relayed through message 2 and 3 at steps 505 and 507. First, the message is an info message containing flash and the digits dialed in message 2. This message is sent from the basestation emulator 101 to the SIP user agent 103. Message 3 is a SIP info message containing the flash and the number dialed to the IMS core 105. The feature server component in the IMS core 105 sends a 200OK info message at step 509 as message 4. It then places party B on hold at step 513. Party B is placed on hold through the existing SIP exchange as shown at step 511.

A call is set up at step 515 between the IMS core 105 and party C. At this point the MRF server 125 is instructed to provide audible ringing to the mobile 107. A re-invite in SIP is sent with the SDP offer information from the MRF server 125 as message 5. A 200OK invite message is sent at step 519 as message 6. This establishes a voice path between the mobile 105 and the MRF server 125 at step 521.

At this point the MRF server 125 is now playing audible ringing to the mobile 107. Shortly thereafter party C answers the call and an answer exchange is set up between party C and the IMS core 107 at step 523. As party C is connected to the mobile 105, the MRF server 125 audible tone is removed.

Now referring to FIG. 5b which is a continuation of the three way calling embodiment which began at FIG. 5a. FIG. 5b shows a re-invite which is message 7 at step 525 from the IMS core 107 to the SIP user agent 103. Message 8 is sent from the SIP user agent 103 back to the IMS core 107 as a 200OK invite at message 8. This message is shown at step 527. At step 529 an acknowledgement message is sent from the IMS core 107 to the SIP user agent 103 as message 9. This acknowledgement message contains SDP answer from party C.

At step 531, a voice path is established between the mobile 105 and party C. At this point the mobile 105 joins party B and party C in a three way conference. As the mobile presses the “SEND” key as message 10 and step 533, a flash message is sent from the mobile to the basestation emulator 101. This message is relayed to the SIP user agent 103 at step 535 as message 11. This message is then translated into SIP and sent as an info flash message as message 12 at step 535 from the SIP user 103 to the feature server component in the IMS core 107. The IMS core 107 sends a 200OK message for that info message at message 13 at step 539. In turn, the SIP user agent 103 then sends message 14 which is an info acknowledgement message to the basestation emulator 101. This connects the mobile party B and party C to the MRF server 125 through the IMS core 107.

The re-invite message is then sent, the SDP offer information as message 15 at step 543. This message is sent from the IMS core 107 to the SIP user agent 103. A 200OK to the invite message is then sent back from the SIP user agent 103 to the IMS core 107 at step 545. At step 551 the mobile is connected to the MRF server 125 via a conference port.

At step 553 a SIP exchange which will be used to add party C to the MRF server 125 conference port is established. At step 555 party C is connected to the MRF 125 server conference port. At step 557 a SIP exchange is then set up to add party B to the MRF server 125 conference port and at step 559 party B is connected to the MRF server 125 conference port. At this point all the parties are connected in conference and the method is complete.

As the case with any of the above described functions that were shown in FIG. 2a through 5b, implementation of these various network elements depends on how the system is used. These functions may be performed by some or all of the network elements in conjunction or separate from one another. These are but a few embodiments of the proposed system and variations may exist. However, this is not meant to limit the claims, but instead to show some embodiments as to how the method and system may be used.

The above description merely provides a disclosure of particular embodiments of the claimed invention and is not intended for the purposes of limiting the same thereto. As such, this disclosure is not limited to only the above-described embodiments. Rather, it is recognized that one skilled in the art could conceive alternative embodiments that fall within the scope of the claims.

1. A method of interworking a 3G1x call control and signaling with session initiation protocol signaling comprising:
receiving an incoming code division multiple access mobile message from an associated mobile station;
mapping between said code division multiple access mobile message and a session initiation protocol message through a basestation emulator and signal initiation protocol user agent; and
sending said session initiation protocol message to an associated internet protocol multimedia subsystem.

2. The method according claim 1 further comprising acknowledging messages between said associated code division multiple access network and said associated internet multimedia subsystem where mapping is not required and satisfying signaling protocol requirements.

3. The method according to claim 1 further comprising parsing said code division multiple access mobile message into multiple classes for transmission to said user agent.

4. The method according claim 3 wherein said multiple classes include operations and messages.

5. The method according to claim 1 further comprising facilitating subscriber features.

6. The method according to claim 5 wherein said subscriber features include three-way calling.

7. The method according to claim 5 wherein said subscriber features include call waiting.

8. The method according to claim 7 wherein said subscriber features include call waiting with caller identification.

9. The method according to claim 1 further comprising assigning a traffic channel via said basestation emulator for voice or data communication.

10. A system used for facilitating communication between code division multiple access mobile units and the internet multimedia subsystem network comprising:
a user agent that bidirectionally facilitates translations between session initiation protocol messages and code division multiple access mobile messages; and
a 1x basestation emulator configured to act as a interface for code division multiple access mobile protocol and interconnect messages and operations with said user agent.

11. The system according to claim 10 wherein said system is housed within a basestation.

12. The system according to claim 10 wherein said basestation is a femto basestation.

13. The system according to claim 10 where said basestation is configured to assign a traffic channel to during a call origination sequence.

14. The system according to claim 10 where said basestation is configured to assign a traffic channel to during a call termination sequence.

15. The system according to claim 10 further comprising a billing database that tracks billing information for basestation origination and termination calls.

16. The system according to claim 10 further comprising a media resource function that processes requests for media services.

17. A method of interworking a 3G1x call control and signaling with session initiation protocol signaling comprising:
receiving an incoming session initiation protocol message at a user agent;
translating said session initiation protocol message to code division multiple access between said user agent and a basestation emulator; and
sending said messages via code division multiple access to an associated mobile unit configured to communicate through code division multiple access messaging.

18. The method according to claim 17 further comprising recognizing communicated messages that do not require translation for processing and transmitting said communicated messages though signal protocol.

19. The method according to claim 17 wherein said incoming session initiation protocol messages are received from an associated internet protocol multimedia subsystem core.

20. The method according to claim 17 further comprising assigning a traffic channel via said basestation emulator for call origination or termination.
